(19) United States
(12) Patent Application Publication
(10) Pub. No.: US 2007/0084108 A1
(43) Pub. Date: Apr. 19, 2007

(54) Telescoping plant support with size-adjustable support base

(76) Inventor: Kay Lynn Hertlein, Chevak, AK (US)

Correspondence Address: PATRICIA M. COSTANZO;PATS PENDING, P.O. BOX 101, ELMA, NY, 14059, US

(21) Appl. No.: 11/250,108

(22) Filed: Oct. 13, 2005

(51) Int. Cl. A01G 17/14

(52) U.S. Cl. 47/47

(57) ABSTRACT

A telescoping plant support comprising a telescoping pole providing support for potted plants and a size-adjustable base supporting the pole is taught. The diameter of the base is size-adjustable for fitting smaller- or larger-sized pots and comprises a central disc base support and at least second and third discs with a flat-ring like structures sized to fit successively about each other. Each of the flat-ring discs are attachable and detachable from one another and the central disc so the plant support may be used with increasingly larger and smaller plant pots. The second and third flat-ring discs may be fixed to the central disc base and one another by at least one separable and reattachable tab connection, or any other known or yet to be know connectors.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to a support for a plant and, more particularly, to a plant supporting device having a telescoping plant support pole and a base part from which the pole part emanates and which base part has a size-adjustable circumference providing for one plant support to be manufactured and purchased for multiple sized plant pots.

The background information discussed below is presented to better illustrate the novelty and usefulness of the present invention. This background information is not admitted prior art.

Historically, pole-like plant supports have been relied upon to support saplings, vines, flowering plants, and others as they grow in height, as well as in girth, so that the trunk or main stem of the plants is able to remain straight, at least until the plant is able to support itself. Often a plant's stem height will increase faster than either the stem width or the plant's root mass, causing the plant's stem to bend in an undesirable manner. Support for potted plants also is required when their growing environments become crowded, such as when a plant starts to outgrow its container. When a plant is kept in a container that is too small for it, the plant's roots are prevented from extending to their natural depth and width, which reduces the plants ability to support itself. In addition, plant supports are required whenever a plant becomes top heavy, such as when a plant is in full bloom or is bearing fruit.

Moreover, when the support pole selected is sized for use with a short stemmed plant, it is not able to provide support to the plant as it grows. In this case, a support pole whose height may be conveniently adjusted to keep pace with the increasing height of the plant is useful, because it eliminates the need to replace the pole each time a plant experiences a significant growth spurt.

Plant supports are also required when plants are potted in a light soil, such as soils that are mixtures of sand, peat moss, vermiculite, and perlite. These soil amendments are used to keep the soil loose and aerated, however such a loose soil cannot provide sturdy support for the plant growing in the soil. Moreover, standard-sized flower pots are limited in depth, often providing an insufficient amount of support for some plants, especially for plants that are top heavy due to a large quantity of leaves, fruits, or flowers. In all of these cases, not only is a plant support needed to support the plant, but additionally, a plant support base is needed to hold the plant support in place so that it may serve to securely stabilize the plant. A disc-like base to which the pole may be attached would provide support for the pole especially when the base is placed firmly beneath the soil.

It is common for a plant to outgrow its pot in only a few months, especially during the spring, creating requiring the plant to be transplanted to a larger pot. When a plant is transplanted, it typically should be transplanted to a pot only one size larger. Pot sizes are given by the diameter of the pot about its upper edge, thus a plant that has outgrown its 10 inch pot should be transplanted to a 12 inch pot. Right after transplanting, the plant is unstable and will remain unstable until the roots grow into the soil of the new pot. Thus, the unstable plant requires a plant support of an appropriate size. Similarly, whenever plants are repotted, such as in the spring when plants that have been over-wintered indoors are prepared for a summer in the garden, or in the fall when tender plants are brought indoors, they generally require some support. Conversely, there are times when a plant becomes too large or when its growth becomes unwieldy, and the plant requires division into several smaller plants that are repotted in pots of smaller diameters which will require plant supports of a smaller size.

There have been several attempts to provide a plant support apparatus that solves the above mentioned problems. Such attempts include plant supports that have a telescoping support pole, while others provide a telescoping pole and a base to support the pole. A telescopic pole should provide for adjustment of the height of the supporting pole, in all cases. However, in those supports that include a pole-supporting base, the base cannot be adjusted to accommodate differently sized pots, causing a consumer to purchase several differently sized supports, if those sizes are even available.

It can be seen, therefore, that there still exists in the art an unmet need for a plant stand whose height may be easily and readily adjusted and whose pole-supporting base may also be adjusted to accommodate various sized pots. What would be most appreciated by gardeners is a plant support apparatus that provides for the height of the support pole of the plant stand to be easily and rapidly adjusted without the need to remove the plant or the plant stand from the pot, where the adjustment may be made without requiring additional parts or tools in order to make the adjustment, and where the plant support apparatus has an adjustable base, so that it may be used and reused in pots of various sizes.

### SUMMARY

The present invention satisfies the currently unmet need for a plant support apparatus that is height and base-size adjustable. The telescoping plant support according to the principles of the present invention constitutes a plant support pole part and a size-adjustable pole-support base part. The plant support pole part is a telescoping pole that may be telescoped upwards to accommodate plants at various stages of their growth. The height adjustments may be made without any need for removing the plant or the plant support apparatus from the pot. The base comprises a disc-like or a ring-like structure which receives a bottom end of the bottom segment of the telescopic pole providing for support for the pole.

In one embodiment of the invention, the bottom section of the bottom segment of the pole support is affixed to the base by screwing a threaded end of the pole into a threaded receiving aperture in the base. The aperture of the base may be situated in the center of the base, or alternatively, it may be center off to one side of the base. The plant support apparatus according to the principles of the present invention may be used in a variety of pot sizes because the base, which, has segments which may be removed or added to provide for the base to fit many different pot sizes. To use the growing plant support, the disc-like base with the support pole attached is placed in the bottom of an otherwise empty flower pot. Potting medium, such as soil and a plant are then added to the pot covering and, thus, securing the plant support apparatus in place.

The current invention, a telescoping plant support with an adjustable base, comprises a telescoping pole-support providing support for potted plants having a size-adjustable base, providing pole-support. The diameter of the telescoping plant support base is size-adjustable, so that the plant support base is usable in either smaller sized flower pots or larger sized pots. The support disc-like base of the telescoping plant support comprises a series of sized flat ring-like discs or rings, with each being sized to fit about the adjacent inner disc or ring and within the adjacent outer disc or ring. The central pole-supporting disc has an aperture for receiving the larger diameter end of the telescoping pole base providing support for the pole. The central pole-supporting disc is sized to fit within a second, outer disc having a flat ring-like disc or ring structure. The second disc or ring has an inner diameter that is large enough to fit about the outer diameter of the central disc support base. In addition, there is at least one additional disc or ring, with an inner diameter sized to fit about the outer diameter of the second ring-like disc.

In a preferred embodiment, each of the successively larger flat ring-like discs are reversibly detachable and attachable to and from the central pole-supporting disc providing for the plant support to be used with increasingly larger and smaller plant pots. A second ring is reversibly fixable to the central pole-supporting ring disc base by at least one separable and reattachable tab connection. In addition, a third ring is reversibly fixable to the second ring by at least one separable and reattachable tab connector. The tab connectors are easy to use. No tools or specials skills are required for the attachment or detachment of the successively larger or smaller ring discs. In one preferred embodiment, the attachment/detachment snap tab system comprises at least one snap fitting per tab end per ring. The central pole-support is fitted with at least one snap part and each ring is fitted with at least one second snap part. Thus the tabs may easily be removed from or placed on the rings and/or disc by simply snapping or unsnapping the relevant snap tab. The means of attaching one ring to another and to the central disc may vary as desired. For example, instead of having snaps, slit-like apertures may be provided in the rings and central disc base for receiving aperture fitting tab ends. It is to be understood that the snap tab and the slit/tab attachment/detachment structure are only two ways of attaching and detaching the base sections to and from each other. Reversible attachment means and methods are numerous and well known in the art and need not be discussed further here. All of these, and others yet to be known, are contemplated for use by the invention.

In another embodiment, one where the base is manufactured as a single disc and then is scored or perforated along circular lines defining the inner and outer circumferences of a series of flat ringing discs, where the ring discs, like the rings discussed above, are sized so that each ring is larger than the ring preceding it from the central base disc outward. In this embodiment, the support base is made to fit smaller flower pots by detaching one or more of the flat ring base parts. This is accomplished by breaking the connection between an inner ring and the adjacent outer ring along a perforated separation line. In one preferred embodiment, the plant support may be sized down only to fit smaller pots as no way of reattaching the discs is provided.

Another preferred embodiment may be sized to fit both smaller and larger pots by simply returning the removed flat ring to its position about the next smaller size base part and where the reaffixed ring is held in place by frictional force between it and its neighbor ring. Another alternative is to have the ring discs attach and detach using sliding groove and ridge attachment means. These attachment means, and many others, are well-known in the art and need not be discussed any further herein.

In order to decrease the size of the plant support base having a total of three detachably attached consecutively sized flat-ring disc parts, the user first removes the outer most flat-ring disc from the next inner flat-ring disc. The user may further reduce the size of the plant support base by removing the next disc from the central base support disc. Reducing the size of the plant support base allows a user to purchase a plant stand with a given base size that may be made smaller to fit smaller pots. In addition, the flat-like ring system used in this invention allows for the plant support base to be adjustable to nearly the precise size needed for a particular pot. Because the size may be adjusted in increments, users will enjoy the advantage of always having a plant support base that fits securely and snugly in a pot no matter what the size of the flower pot.

Where the plant support base has initially been reduced in size in order to fit a smaller pot, the plant support may subsequently be adjusted to a larger size to accommodate a growing plant's need for a larger sized pot. To increase the size of the plant support base, the user first attaches a flat-ring disc about the central support disc. The flat-ring disc is pre-sized to fit about the central base part and is attaché to the base part via a connection made for such attachment, such as a tab into a slit type connector aperture. The plant support base may be made even larger by attaching a flat-ring disc sized to fit about a second disc that is fitted about a central disc to the second disc by reattaching the separable tab/slit connection. This system is not only very user friendly, but it allows for size adjustments in small increments to, for example, adjust the size of the plant support to fit larger sized flower pots, which allows the user to increase the base gradually to accommodate increasing sizes of growing plants.

It should be noted that the invention may encompass a variety of forms. The telescoping plant support base may be made from a variety of different materials, including plastic, metal, and wood. In addition, the number of ring discs or rings that may be added to the plant support base is unlimited. In addition, the width of the rings may differ depending on the needs of the user. Allowing for an unlimited number of rings and varying widths of the rings will allow the user maximum flexibility altering the size of their plant support base.

The present invention makes available all of the above described accomplishments by providing for a telescoping plant support with a base, comprising:
a) a telescoping pole-support means providing support for plants;
b) a size-adjustable base with a diameter wherein the base provides support for the telescoping plant support.

In a preferred embodiment the telescoping plant support further comprises wherein said diameter of said base may be size-adjusted to fit smaller and larger sized pots.

It is further contemplated that the telescoping plant support base may be a central disc base supporting said telescoping pole-support means having at least one first ring adapted for reversible attachment about said central disc base, and at least one second ring adapted for reversible attachment about said first ring disc, wherein each of said ring discs are separable from the rings about which they are attached, therein providing for the telescoping plant support to be used with increasingly smaller and larger plant pots.

It is also contemplated that plant support further comprises at least a first ring reversibly attachable to the central disc base by at least one separable connector tab with the at least second ring reversibly attachable to the at least second ring by at least one separable connector tab.

It is yet further contemplated that the telescoping plant support further comprises wherein the at least one reversibly attachable connector tab end is fitted with a snap-able connector, wherein the central disc base is fitted with a complementary snap-able connector for the reversible connection of the at least first ring, wherein the at least first ring is fitted with a complementary snap-able connector for the reversible attachment of the at least second ring, and wherein the at least second ring is fitted with a complementary snap-able connector for the reversible attachment of an at least third ring.

Alternatively, the telescoping plant support further comprises wherein the at least one connector tab is reversibly attachable to the central base and to each of the rings via at least one slit in each of the rings adapted for receiving an aperture fitting connector tab end.

The telescoping plant support, as recited in claim 1, further comprising wherein the telescoping plant support is made by a molding technique and that the plant support may be made of a plastic, a metal, or of a wood.

In still yet another preferred embodiment, the telescoping plant support, further comprises:
a. a central disc base supporting the telescoping pole-support means;
b. at least a first ring disc having a flat-ring like structure with inner and outer diameters sized for being attachable to and detachable from the central disc;
c. at least a second ring disc having a flat-ring like structure with inner and outer diameters sized for being attachable to and detachable from the first ring disc, and
d. wherein each of the flat-ring discs are attachable to and detachable from the disc each is sized to be attached to, therein providing for the telescoping plant support to be used with increasingly larger and smaller plant pots,
   wherein the at least a first flat-ring disc fixed to the central disc base by at least one reversibly attachable connector tab, and an at least a second flat-ring disc fixed to the at least a first flat-ring disc by at least one reversibly attachable connector tab.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a side plan view of the telescoping plant support stand of the present invention.

FIG. 2 is a top plan view of the telescoping plant support stand base, as shown in FIG. 1.

FIG. 3 is an angled perspective view of an alternate design for the base of the telescoping plant stand.

### A LIST OF THE REFERENCE NUMBERS AND PARTS OF THE INVENTION TO WHICH NUMBERS REFER

2 Telescoping plant support pole.
2a A first section of telescoping plant support pole for telescoping into and out of second section of telescoping support pole 2b.
2b Second section of telescoping support pole having a hollow interior for receiving 2a.
2c Third section of telescoping support pole having a hollow interior for receiving 2b.
2d Fourth section of telescoping support pole having a hollow interior for receiving 2c.
4 Size-adjustable disc-like pole support base of plant stand with means for receiving and holding telescoping support pole.
4a Central pole-support disc of base 4.
4b First flat ring-like disc for placement about 4a.
4c Second flat ring-like disc for placement about 4b.
5 Receiving aperture in plant support base 4 for receiving and supporting pole-support 2.
8a Perforated, or similarly treated, separation lines between flat ring-like discs 4a and 4b
8b Perforated, or similarly treated, separation lines between flat ring-like discs 4b and 4c
10 Telescoping plant support stand with size-adjustable base
12 Ringed plant support base.
12a Central pole-support disc of base of another preferred embodiment.
12b A first ring for reversible attachment to 12a.
12c A second ring for reversible attachment to 12b.
14 Reversibly attachable connector tabs.
16 Snap attachment means located on central pole-support disc and on ring base parts.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms, some of which are describer throughout. Therefore, the embodiments taught herein are provided with the understanding that the present disclosure is intended as illustrative and is not intended to limit the invention to the embodiments described herein.

The current invention, of a telescoping plant support comprising a telescoping pole providing support for potted plants and a size-adjustable base providing support for the pole. The diameter of the telescoping plant support base is size-adjustable providing for use in smaller-sized flower pots or in larger pots. The base of the telescoping plant support comprises a multi-part disc that comprises a central base disc support having an aperture for receiving, holding, and supporting the pole part. In addition, there is at least one additional flat ring-like disc, with an inner diameter sized to fit about the outer diameter of the central base disc. Furthermore, for those embodiments offering a multitude of additional flat ring-like discs, each of the successively larger flat ring-like discs are reversibly detachable and attachable to and from one another and the central ring-like base, providing for the plant support to be used with increasingly larger and smaller plant pots. A first ring may be affixed to the central base disc by at least one reversibly separable connector tab.

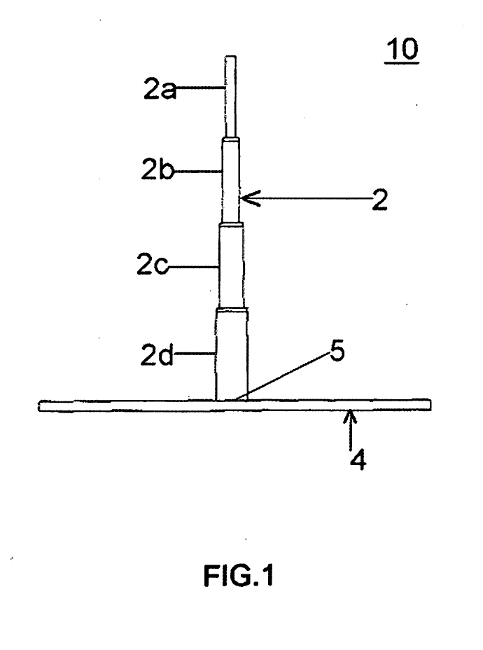

Turning now to the drawings, FIG. 1, a side plan view of plant support stand 10, illustrates the several parts of telescoping pole 2 and size-adjustable base 4. As illustrated in FIG. 1, telescoping pole 2 is comprised of four sections 2a, 2b, 2c, and 2d which sections are retractable into and releasable from each other providing for desired height adjustment of the support pole 2 to the height of the plant. It is to be understood that although FIG. 1 uses four telescoping sections, the pole may comprise fewer than four telescoping sections or greater than four telescoping sections. One end of telescoping support pole 2 is received by and securely held within aperture 5 situated within size-adjustable base 4. If desired, pole 2 may be securely attached to size-adjustable base 4 using a screw thread on the telescoping pole 2, which is accepted by mating screw threads within the inner cylindrical part of aperture 5. In addition, telescoping pole 2 may simply be supported by size-adjustable base 4 through a friction fit between the inner surface of cylindrical pole receiving aperture 5 and the received end of the support pole. Alternatively, there are many other well known and used means in the art for supporting support pole in support base, which need not be discussed any further here. Plant stand 10 depicted in FIG. 1, is not limited by its material of construction and may be constructed from plastic, wood, or metal, for example.

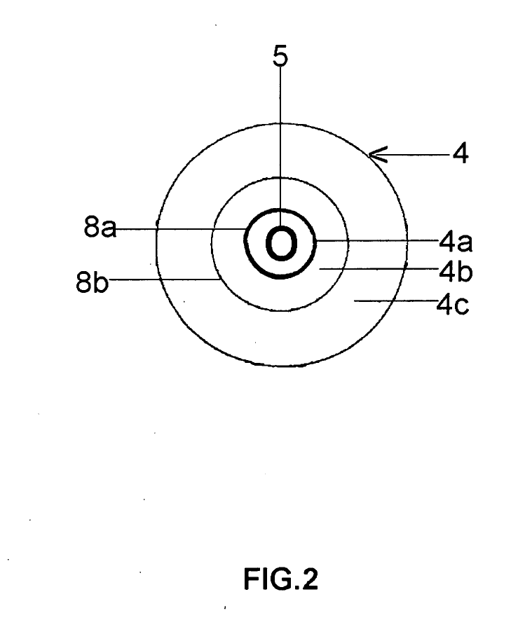

FIG. 2 is a top plan view of the plant stand base, as shown in FIG. 1. Size-adjustable base 4 comprises central pole-support disc base 4a with aperture 5 for receiving pole 2, as illustrated in FIG. 1, flat ring-like disc 4b, and flat ring-like disc 4c. It should be noted that, although there are three discs depicted in FIG. 2, the invention may utilize any desired number of discs, where the width (i.e., the radius) of each disc may of vary. In the present embodiment, central pole-support base disc 4a, flat ring-like disc 4b, and flat ring-like disc 4c are received by the consumer seemingly constructed as a single large disc. The rings are visibly differentiate-able by score lines or perforations 8a and 8b imprinted onto a surface of the base disc. In this embodiment, flat ring-like disc 4c may be separated from flat ring-like disc 4b and removed making size-adjustable base 4 smaller. If the user requires a plant support with a smaller diameter, flat ring-like disc 4b may be separated and removed from central pole-support disc 4a. The score lines or perforations provide for easy and rapid separation of flat ring-like disc 4c from flat ring-like disc 4b and of separation of flat ring-like disc 4b from central pole support base 4a. In one favored embodiment, the separated and removed discs cannot be reattached after removed. However, in another favored embodiment, one in which the entire base disc is made thicker, or where each of the discs has a ribbed edge about its outer and/or inner diameter, the sections may be replaced to their original positions and held there by friction adhesion.

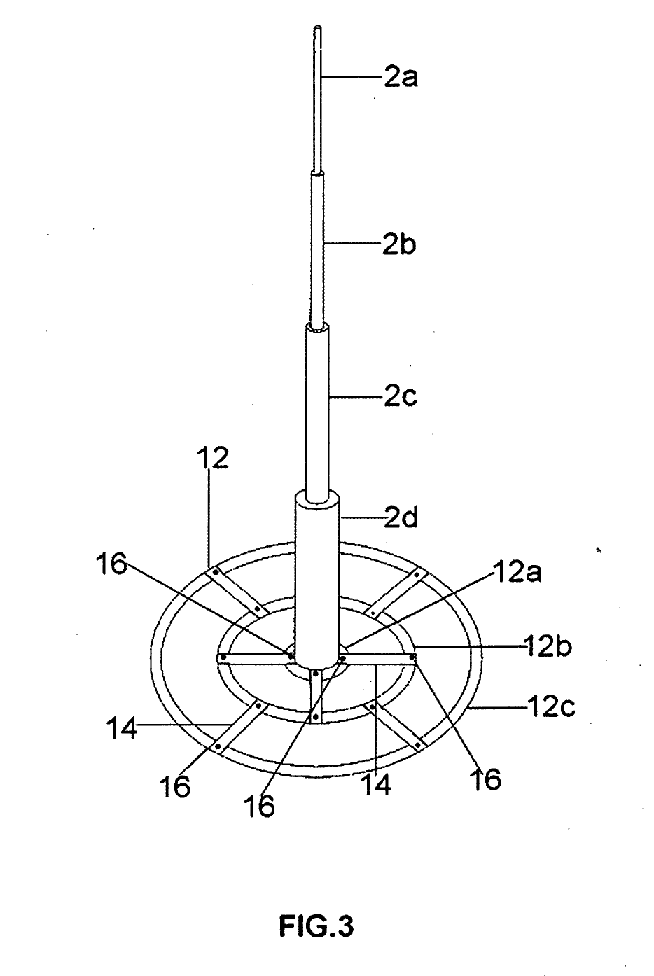

FIG. 3 is a perspective view of another preferred embodiment of the telescoping plant stand made according to the principles of the present invention illustrating another configuration that may be used to provide for a size-adjustable base. In this embodiment, the plant support base 12 may be made larger or smaller depending on the needs of the user by separating and reattaching a series of detachably attachable rings 12a-12c. In is to be understood that in this embodiment, the number of base rings that can be added is as desired. Also, the width of the rings may vary based upon the needs or preferences of the user. If it is to be desired to reduce the amount of material used in the construction of a plant support stand, the width of the base rings is minimized. In this embodiment, central base pole support ring 12a is connected to ring 12b via reversibly attachable connector tabs 14. Snap connectors 16 are provided on each end of connector tabs 14. Mating snap connectors 16 are provided on the surface of each of the rings for receiving the snap connectors on the connector tabs. It should be noted that while the embodiment depicted in FIG. 3 contains four reversibly separable connector tabs between the rings 12a through 12c, there may be as few or as many separable connector tabs as desired between any of the rings. Such molded snaps have become popular recently, and are commonly found as part of ready to use salad and baked goods products. The use of the snapping connectors allows a user to quickly and easily remove and replace the reversibly attachable connector strips from and to each other providing for a plant support base having a desired size.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A telescoping plant support, comprising:
a) a telescoping pole-support means providing support for plants;
b) a size-adjustable base with a diameter, said base providing support for the telescoping pole-support, wherein the diameter of said base is size-adjustable.

2. The telescoping plant support, as recited in claim 1, further comprising wherein said diameter of said base may be size-adjusted to fit smaller and larger sized pots.

3. The telescoping plant support, as recited in claim 2, wherein said disc base further comprises:
a) a central disc base supporting said telescoping pole-support means;
b) at least one first ring adapted for reversible attachment about said central disc base,
c) at least one second ring adapted for reversible attachment about said first ring disc,
d) wherein each of said ring discs are separable from the rings about which they are attached, therein providing for the telescoping plant support to be used with increasingly smaller and larger plant pots.

4. The telescoping plant support, as recited in claim 3, further comprising:
a) said at least first ring reversibly attachable to the central disc base by at least one separable connector tab;
b) said at least second ring reversibly attachable to the at least second ring by at least one separable connector tab.

5. The telescoping plant support, as recited in claim 4, further comprising wherein said at least one reversibly attachable connector tab end is fitted with a snap-able connector.

6. The telescoping plant support, as recited in claim 5, further comprising wherein said central disc base is fitted with a complementary snap-able connector for the reversible connection of said at least first ring.

7. The telescoping plant support, as recited in claim 5, further comprising wherein said at least first ring is fitted with a complementary snap-able connector for the reversible attachment of said at least second ring.

8. The telescoping plant support, as recited in claim 5, further comprising wherein said at least second ring is fitted with a complementary snap-able connector for the reversible attachment of an at least third ring.

9. The telescoping plant support, as recited in claim 4, further comprising wherein said at least one connector tab is reversibly attachable to said central base and to each of said rings via at least one slit in each of the rings adapted for receiving an aperture fitting connector tab end.

10. The telescoping plant support, as recited in claim 1, further comprising wherein said telescoping plant support is made by a molding technique.

11. The telescoping plant support, as recited in claim 1, further comprising wherein said plant support is made of a plastic.

12. The telescoping plant support, as recited in claim 1, further comprising wherein said plant support is made of a metal.

13. The telescoping plant support, as recited in claim 1, further comprising wherein said plant support is made of a wood.

14. The telescoping plant support, as recited in claim 1, further comprising:
a) a central disc base supporting said telescoping pole-support means;
b) at least a first ring disc having a flat-ring like structure with inner and outer diameters sized for being attachable to and detachable from said central disc;
c) at least a second ring disc having a flat-ring like structure with inner and outer diameters sized for being attachable to and detachable from said first ring disc, and
d) wherein each of said flat-ring discs are attachable to and detachable from the disc each is sized to be attached to, therein providing for the telescoping plant support to be used with increasingly larger and smaller plant pots.

15. The telescoping plant support, as recited in claim 14, further comprising:
a) said at least a first flat-ring disc fixed to said central disc base by at least one reversibly attachable connector tab;
b) said at least a second flat-ring disc fixed to said at least a first flat-ring disc by at least one reversibly attachable connector tab.

16. The telescoping plant support, as recited in claim 15, further comprising wherein said plant support is made of a plastic.

17. The telescoping plant support, as recited in claim 15, further comprising wherein said plant support is made of a metal.

18. The telescoping plant support, as recited in claim 15, further comprising wherein said plant support is made of a wood.

19. A telescoping plant support with an adjustable base, comprising:
a) a telescoping plant support means providing support for plants;
b) a central disc base means for supporting said telescoping plant support means;
c) at least a first detachable flat-ring disc means attached about said central disc,
d) at least a second detachable flat-ring disc means attached about said first flat-ring disc,
e) wherein each of said flat-ring discs is detachable from the disc about which it is fixed, therein providing for the telescoping plant support to be used with increasingly smaller plant pots.

20. A telescoping plant support with an adjustable base, comprising:
a) a telescoping pole-support means providing support for plants;
b) a central disc base means for supporting said telescoping plant support means;
c) at least a first detachable flat-ring disc means attached about said central disc,
d) at least a second detachable flat-ring disc means attached about said first flat-ring disc,
e) wherein each of said flat-ring discs is attachable to and detachable from the disc about which it is attached, therein providing for the telescoping plant support to be used with increasingly smaller plant pots.
